(19) United States
(12) Patent Application Publication
(10) Pub. No.: US 2005/0278198 A1
(43) Pub. Date: Dec. 15, 2005

(54) Methods and systems for managing a portfolio of insurance products

(76) Inventors: Darren Huxol, Prairie Village, KS (US); Ajay Gupta, Esher (GB); Jennifer Patterman, Munich (DE); Andrew Rayner, Elstead (GB); Andreas Schaal, Munchen (DE)

Correspondence Address: John S. Beulick;Armstrong Teasdale LLP, Suite 2600, One Metropolitan Square, St. Louis, MO, 63102, US

(21) Appl. No.: 10/864,144

(22) Filed: Jun. 9, 2004

(51) Int. Cl. G06F 17/60

(52) U.S. Cl. 705/4; 705/10; 705/36

(57) ABSTRACT

A method for managing a portfolio of insurance products is provided. The method uses a computer system coupled to a database. The database has data relating to insurance products stored therein. The data relates to at least one of premiums, commissions, insurance policies, reinsurance policies, contracts, policy limits, claims, and losses. The method includes analyzing data stored within the database using the computer system including segmenting the insurance products included within the portfolio into predefined risk categories, analyzing market trends for at least a segment of an insurance industry, and recommending a sales indicator for each risk category based on the portfolio analysis and the market trends analysis wherein the sales indicator indicates whether an insurer will increase, decrease, or maintain an amount of business currently being solicited from potential insureds for the corresponding risk category.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to managing a portfolio of insurance products and, more particularly, to network-based methods and systems for managing a portfolio of insurance products.

Within the United States, and throughout the world, the insurance industry is a very complex and diverse industry. For example, a plurality of different insurance companies, including primary insurance companies and reinsurance companies, offer a variety of insurance products to potential insureds. When an insurer enters into an insurance contract (i.e., sells an insurance policy) with an insured, the insurance contract becomes part of the insurer's portfolio. Because many insurance companies are engaged in a business, insurers continuously monitor and manage their portfolios in an effort to enhance the financial profits for their respective companies.

More specifically, each insurer typically analyzes its portfolio, including premiums, commissions, insurance policies, reinsurance policies, contracts, policy limits, claims, and/or losses, to determine whether insurance contracts included within a portfolio are profitable. For example, an insurer may analyze an insurance contract to determine whether premiums collected for that insurance contract are greater than claims paid out for the same contract. In addition to analyzing past performance, some insurers may also attempt to predict the future performance of their portfolio including predicting which contracts are expected to be profitable in the future. Insurers may also analyze market trends for at least a segment of the insurance industry when predicting the future profitability of insurance contracts.

After analyzing its portfolio, an insurer may then have a better basis for selecting the insurance products to be targeted for increased sales and the insurance products to be targeted for decreased sales.

However, because of the diversity and complexity of the industry, insurers may experience significant difficulties identifying and communicating this information to the individuals responsible for marketing and selling such insurance products.

### BRIEF DESCRIPTION OF THE INVENTION

In one aspect, a method for managing a portfolio of insurance products is provided. The method uses a computer system coupled to a database. The database has data relating to insurance products stored therein. The data relates to at least one of premiums, commissions, insurance policies, reinsurance policies, contracts, policy limits, claims, and losses. The method includes analyzing data stored within the database using the computer system including segmenting the insurance products included within the portfolio into predefined risk categories, analyzing market trends for at least a segment of an insurance industry, and recommending a sales indicator for each risk category based on the portfolio analysis and the market trends analysis wherein the sales indicator indicates whether an insurer will increase, decrease, or maintain an amount of business currently being solicited from potential insureds for the corresponding risk category.

In another aspect, a method for managing a portfolio of reinsurance products is provided. The method uses a computer system coupled to a database and in communication with an underwriting computer system. The database has data relating to reinsurance products stored therein. The data relates to at least one of premiums, commissions, insurance policies, reinsurance policies, contracts, policy limits, claims, and losses. The method includes analyzing data stored within the database using the computer system including segmenting the reinsurance products included within the portfolio into predefined risk categories including major lines of business, sublines, customer segments, regional segments, and agreement types, analyzing market trends for at least a segment of an insurance and reinsurance industry, and recommending a sales indicator for each risk category based on the portfolio analysis and the market trends analysis wherein the sales indicator indicates whether a reinsurer will increase, decrease, or maintain an amount of business currently being solicited from potential insureds for the corresponding risk category. The method also includes approving by the reinsurer the recommended sales indicator for each risk category, storing the approved sales indicators in the database, displaying the approved sales indicators for each risk category on the computer system, creating at the computer system a data file representing an approved sales indicator including data relating to the risk category corresponding to the approved sales indicator, exporting the data file from the computer system to the underwriting computer system, mapping the data file at the underwriting computer system, and utilizing the mapped data file to assign the approved sales indicator for the risk category to at least one insurance contract included within the underwriting computer system.

In another aspect, a network based system for managing a portfolio of insurance products is provided. The system includes a database for storing data relating to insurance products wherein the data relates to at least one of premiums, commissions, insurance policies, reinsurance policies, contracts, policy limits, claims, and losses, and a computer system configured to be coupled to the database. The computer system is further configured to store data in the database, analyze the data including segmenting the insurance products included within the portfolio into predefined risk categories, analyze market trends for at least a segment of an insurance industry, and prompt a user to recommend a sales indicator for each risk category based on the portfolio analysis and the market trends analysis wherein the sales indicator indicates whether an insurer will increase, decrease, or maintain an amount of business currently being solicited from potential insureds for the corresponding risk category.

In another aspect, a network based system for managing a portfolio of reinsurance products is provided. The system includes an underwriting computer system, a database, and a computer system configured to be coupled to the database and the underwriting computer system. The database stores data relating to reinsurance products wherein the data relates to at least one of premiums, commissions, insurance policies, reinsurance policies, contracts, policy limits, claims, and losses. The computer system is further configured to store data in the database, analyze the data including segmenting the reinsurance products included within the portfolio into predefined risk categories including major lines of business, sublines, customer segments, regional segments, and agreement types, and analyze market trends for at least a segment of an insurance and reinsurance industry. The computer system is also configured to prompt a user to recommend a sales indicator for each risk category based on the portfolio analysis and the market trends analysis wherein the sales indicator indicates whether a reinsurer will increase, decrease, or maintain an amount of business currently being solicited from potential insureds for the corresponding risk category, store the approved sales indicators in the database, display the approved sales indicators for each risk category, create a data file representing an approved sales indicator including data relating to the risk category corresponding to the approved sales indicator, and export the data file to the underwriting computer system for assigning the approved sales indicator for the risk category to at least one insurance contract included within the underwriting computer system.

In another aspect, a computer program embodied on a computer readable medium for managing a portfolio of insurance products is provided. The program includes at least one code segment that receives data relating to insurance products wherein the data relating to at least one of premiums, commissions, insurance policies, reinsurance policies, contracts, policy limits, claims, and losses, maintains a database by adding, deleting and updating the data, and analyzes the data including segmenting the insurance products included within the portfolio into predefined risk categories. The program further includes at least one code segment that analyzes market trends for at least one segment of an insurance industry, and prompts a user to recommend a sales indicator for each risk category based on the portfolio analysis and the market trends analysis wherein the sales indicator indicates whether an insurer will increase, decrease, or maintain an amount of business currently being solicited from potential insureds for the corresponding risk category.

In another aspect, a method for targeting sales of insurance products is provided. The method uses a computer system coupled to a database. The database stores data relating to insurance products previously sold by an insurer. The data relates to at least one of premiums, commissions, insurance policies, reinsurance policies, contracts, policy limits, claims, and losses. The method includes determining a profitability for an insurance product sold by the insurer using the computer system to analyze data stored within the database, analyzing market trends for at least a segment of an insurance industry, and recommending a sales indicator for the insurance product for targeting future sales of the insurance product wherein the sales indicator is based on the profitability of the insurance product and the market trends analysis. The sales indicator indicates whether the insurer will increase, decrease, or maintain an amount of business currently being solicited from potential insureds for the insurance product.

In another aspect, a network-based system for targeting sales of insurance products is provided. The system includes a database for storing data relating to insurance products previously sold by an insurer, and a computer system configured to be coupled to the database. The data relates to at least one of premiums, commissions, insurance policies, reinsurance policies, contracts, policy limits, claims, and losses. The computer system is further configured to store data in the database, determine a profitability for an insurance product sold by the insurer using the computer system to analyze data stored within the database, analyze market trends for at least a segment of an insurance industry, and prompt a user to recommend a sales indicator for the insurance product for targeting future sales of the insurance product. The sales indicator is based on the profitability of the insurance product and the market trends analysis. The sales indicator indicates whether the insurer will increase, decrease, or maintain an amount of business currently being solicited from potential insureds for the insurance product.

### BRIEF DESCRIPTION OF THE DRAWINGS

FIG. 1 is a simplified block diagram of a Strikezone Manager System (SMS) in accordance with one embodiment of the present invention.

FIG. 2 is an expanded version block diagram of an example embodiment of a server architecture of the SMS.

FIG. 3 is an expanded block diagram illustrating further detail of an example embodiment of a server architecture of the SMS.

FIG. 4 is a flowchart illustrating exemplary processes utilized by a SMS.

FIG. 5 is an example embodiment of a user interface displaying a my strikezones page within a SMS.

FIG. 6 is an example embodiment of a user interface displaying a product leader actions page within a SMS.

FIG. 7 is an example embodiment of a user interface displaying a portfolio manager page within a SMS.

FIG. 8 is an example embodiment of a user interface displaying a risk manager page within a SMS.

FIG. 9 is an example embodiment of a user interface displaying a customer leader internal values page within a SMS.

FIG. 10 is an example embodiment of a user interface displaying a customer leader external values page within a SMS.

FIG. 11 is an example embodiment of a user interface displaying a strikezone manager page within a SMS.

FIG. 12 is an example embodiment of a user interface displaying a reports overview page within a SMS.

FIG. 13 is an example embodiment of a user interface displaying a data drill combined page within a SMS.

FIG. 14 is an example embodiment of an user interface displaying a property strikezone overview report page within a SMS.

### DETAILED DESCRIPTION OF THE INVENTION

Exemplary embodiments of systems and processes that facilitate integrated network-based electronic reporting and workflow process management related to a Strikezone Manager System (SMS) are described below in detail. The systems and processes facilitate, for example, electronic submission of information using a client system, automated extraction of information, and web-based reporting for internal and external system users. A technical effect of the systems and processes described herein include at least one of enabling at least one of a reinsurance company and an insurance company (collectively referred to herein as an “insurer”) to manage a portfolio of insurance products. More specifically, the SMS enables a user to analyze data relating to the insurance products included within a portfolio, segment the insurance products included within the portfolio into predefined risk categories, analyze market trends for at least a segment of an insurance industry, and recommend a sales indicator for each risk category based on the portfolio analysis and the market trends analysis wherein the sales indicator indicates whether an insurer will increase, decrease, or maintain an amount of business currently being solicited from potential insureds for the corresponding risk category.

In the example embodiment, the data being analyzed is stored in a database and relates to at least one of premiums, commissions, insurance policies, reinsurance policies, contracts, policy limits, claims, and losses.

The SMS also enables a user to submit the recommended sales indicator for each risk category to an approval process, store the approved sales indicators in a database, and display the approved sales indicators for each risk category on a computer system to enable the user to solicit business for the insurer based on the portfolio analysis and the market trends analysis.

After the proposed sales indicator has been “finally approved”, the SMS transmits the approved change to the database. SMS then performs several automated tasks including at least one of: creating CSV (comma separated values) files for a GUS (Global Underwriting System), creating Internet files including creating HTML files using an external template and then publishing a list of all “external” view files to an Internet index, creating Intranet files including creating HTML files using an internal template and then publishing a list of all “internal” view files to an intranet index, and creating PDF files including creating corresponding PDF files for each sales indicator which are saved both within SMS and also on an intranet. The CSV files are exported from SMS to GUS for uploading and mapping into the GUS system. This enables an automatic color-coding of deals to be made once an underwriter enters parameters into GUS.

In an alternative embodiment, SMS and GUS are directly linked such that information is exchanged between SMS and GUS without having to first create CSV files for the GUS. In other words, SMS and GUS may be linked in communication such that SMS would automatically transmit information to GUS regarding updated strikezone parameters, and would automatically receive information from GUS on contracts and their strikezone colors.

A strikezone (SZ), also known as a product strikezone and also referred to herein as a sales indicator, indicates a current risk appetite for an insurer by product line and sublines. A strikezone is used by an insurer to define product targets for the insurer for a specific period of time. Accordingly, a strikezone enables an insurer to target the insurance products that it wants to sell more of, and those insurance products it want to sell less of.

In the example embodiment, SMS is utilized to submit a recommended sales indicator to an approval process, and track the recommended sales indicator through the approval process. At least some of the roles that may be involved in the approval and tracking processes include: a product leader, a portfolio manager, a risk manager, a direct customer leader, a broker customer leader, an underwriter, and a strikezone manager. A product leader is a main role within a product team who manages strikezone packages. A portfolio manager is another product team role that oversees and agrees with changes made by a product leader to strikezone packages. A risk manager is assigned to each product team and confirms that he understands changes made to a strikezone by a product team. A strikezone manager has overall control over the workflow and can act on behalf of any person that may be delaying the approval process. The strikezone manager also receives all notifications of changes and can extract extra reports relating to system performance.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

Moreover, the systems and processes described herein may be utilized by a variety of users. For example, the SMS may be utilized by at least one of a primary insurance carrier, a reinsurance company, and other business entities that advise insurance companies on portfolio management issues. For example, the SMS could be utilized by a company that analyzes data relating to an insurer's insurance products included within a portfolio, segments these insurance products included within the portfolio into predefined risk categories, analyzes market trends for at least a segment of an insurance industry, and then recommends a sales indicator for each risk category based on the portfolio analysis and the market trends analysis. This recommendation would then be submitted to the insurer for approval and implementation.

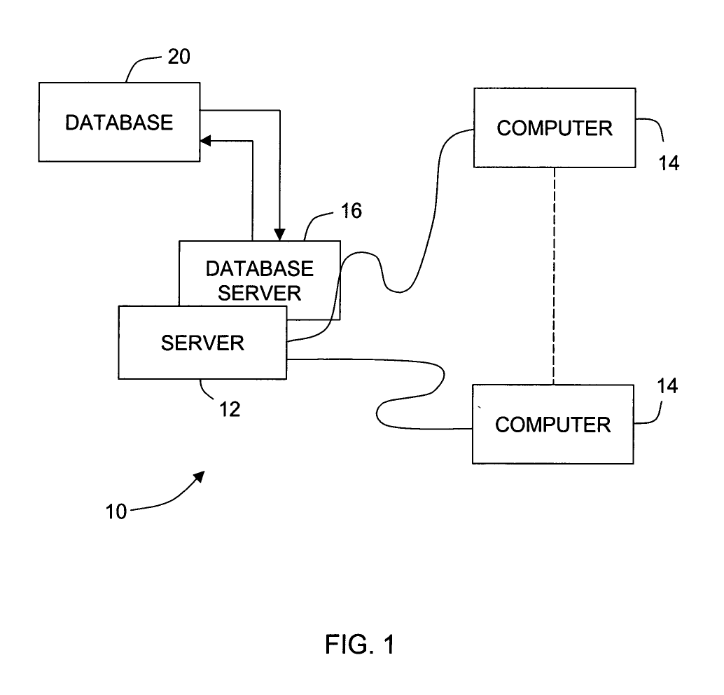

FIG. 1 is a simplified block diagram of a Strikezone Manager System (SMS) 10 including a server system 12, and a plurality of client sub-systems, also referred to as client systems 14, connected to server system 12. Computerized modeling and grouping tools, as described below in more detail, are stored in server 12 and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

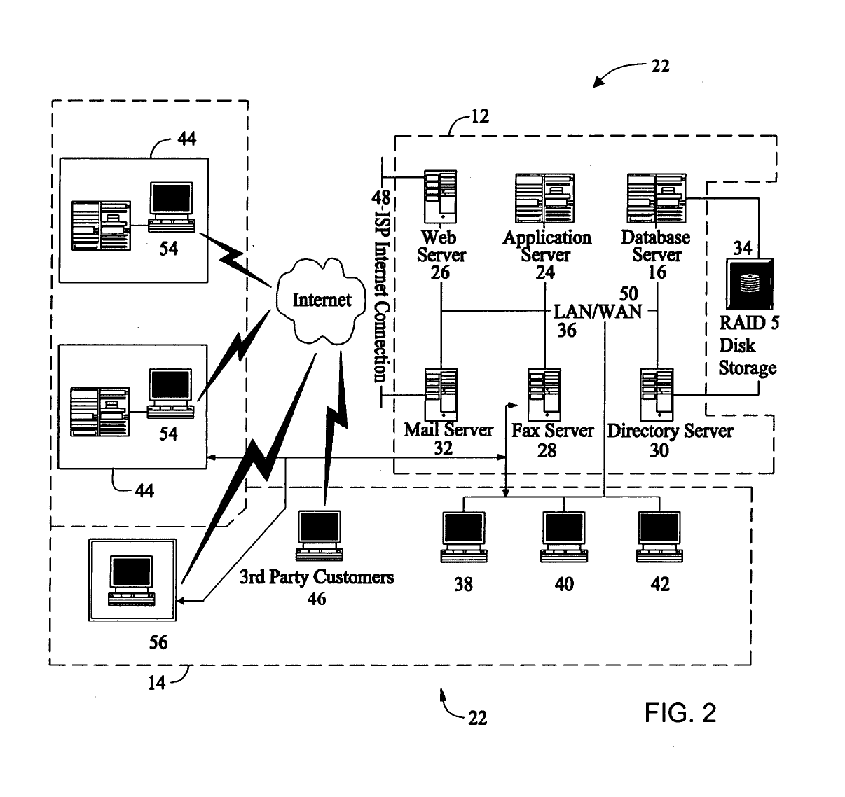

FIG. 2 is an expanded block diagram of an exemplary embodiment of a server architecture of a SMS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., clients/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access SMS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

System 22 accumulates a variety of confidential data and has different access levels to control and monitor the security of and access to system 22. Authorization for access is assigned by system administrators on a need to know basis. In one embodiment, access is provided based on job functions. In yet another embodiment, system 22 provides access based on business-entity. The administration/editing capabilities within system 22 are also restricted to ensure that only authorized individuals have access to modify or edit the data existing in the system. System 22 manages and controls access to system data and information.

The architectures of system 22 as well as various components of system 22 are exemplary only. Other architectures are possible and can be utilized in connection with practicing the processes described below.

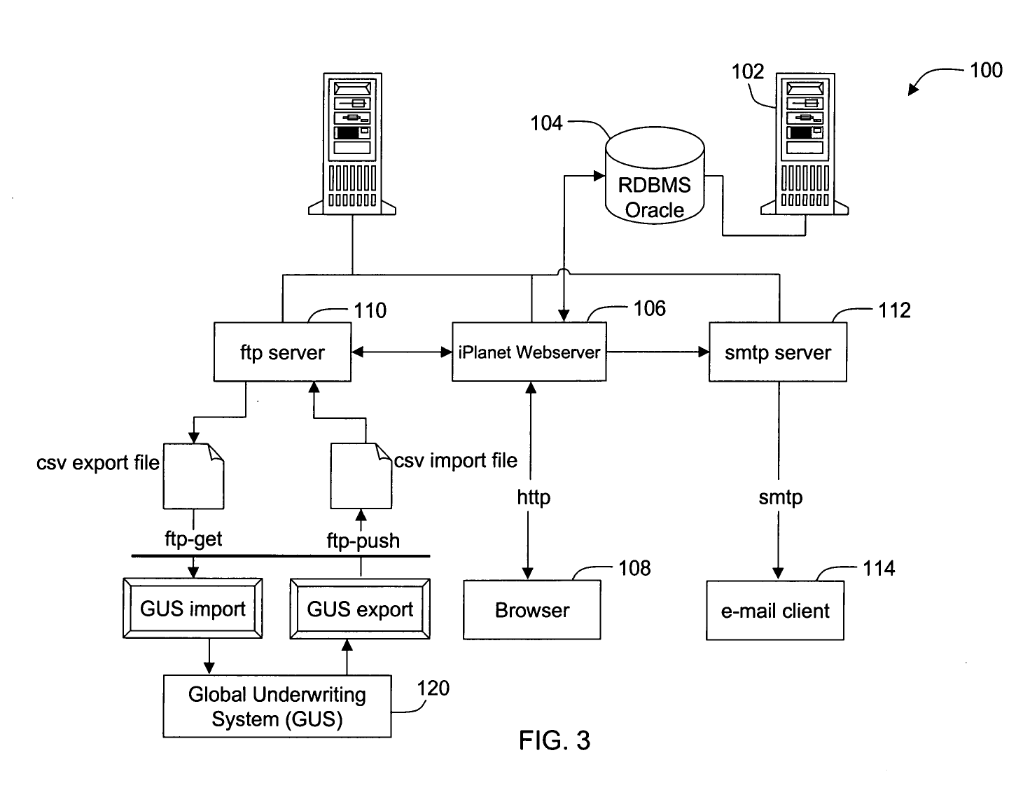

FIG. 3 is an expanded block diagram illustrating further detail of an exemplary embodiment of a server architecture of a SMS 100. System 100 includes a server system 102 in communication with database 104. Database 104 may include a Relational Management Database System, for example, an Oracle® RDBMS database. (Oracle is a registered trademark of Oracle Corporation, Redwood City, Calif.). Database 104 is in communication with a web server 106, which may include, for example, an iPlanet® Webserver manufactured by Sun Microsystems. (iPlanet is a registered trademark of Sun Microsystems, Inc., Palo Alto, Calif.).

Web server 106 includes a browser 108 for HTTP (HyperText Transfer Protocol) files. Web server is also in communication with a FTP (File Transfer Protocol) server 110 and a SMTP (Simple Mail Transfer Protocol) server 112. SMTP server 112 is utilized for e-mailing 114 notifications to clients.

FTP server 110 is in further communication with a Global Underwriting System (GUS) 120. FTP server 110 is configured to automatically create CSV (comma separated values) files, which are exported from FTP server 110 and imported to GUS 120. GUS 120 is also configured to export CSV files, which are imported into FTP server 110.

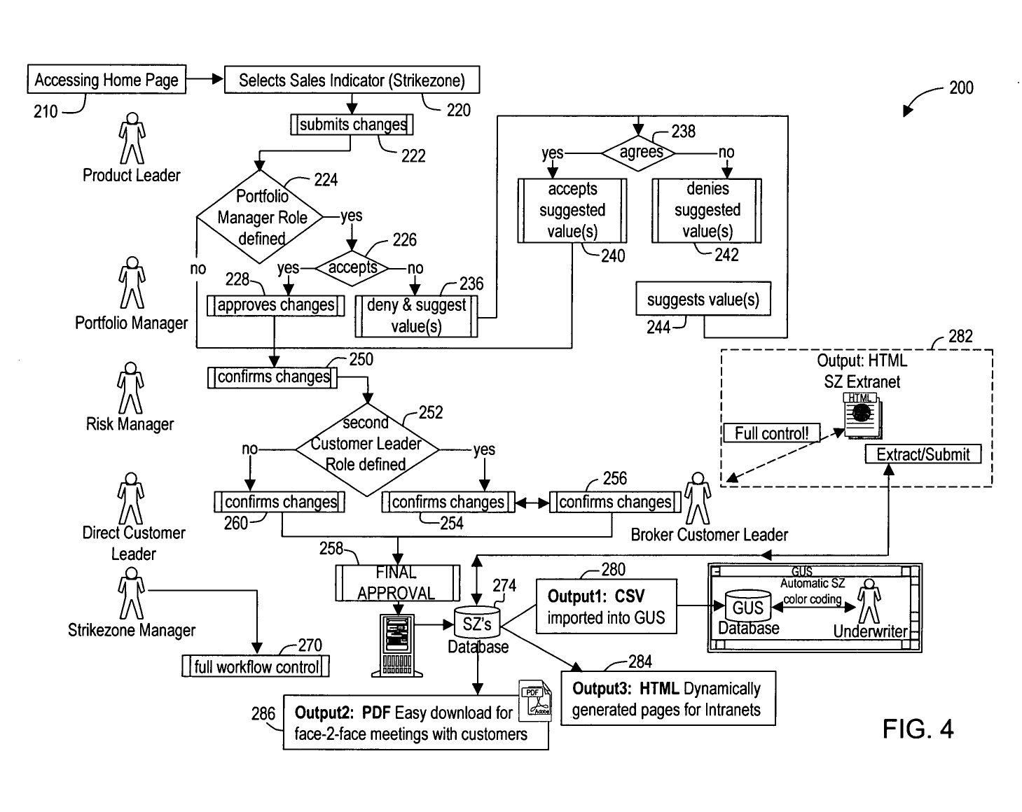

FIG. 4 is a flowchart 200 illustrating exemplary processes utilized by SMS 10 (shown in FIG. 1). The technical effect of the processes and systems described herein is achieved by a user first accessing 210 a user interface, such as a home page, of the web site through client system 14 (shown in FIG. 1). In one embodiment, client system 14, as well as server system 12 (shown in FIG. 1), are protected from access by unauthorized individuals. The user logs-in to system 10 using a password (not shown) and an employee user login for security. The technical effect is further achieved when a product leader for an insurer selects 220 a strikezone, also referred to as a sales indicator, for a risk category and submits 222 a proposed change to the selected strikezone. The product leader can propose changing or maintaining the selected strikezone, and can provide a reason for changing the strikezone.

System 10 then determines 224 whether a portfolio manager role has been defined within the system. If a portfolio manager role has been defined, system 10 directs the proposed change from the product leader to the portfolio manager. The portfolio manager is then prompted 226 to accept or decline the strikezone change proposed by the product leader. If the portfolio manager accepts 228 the proposed strikezone change, the proposed change is communicated to a risk manager.

If, however, the portfolio manager declines 236 the proposed strikezone change, the portfolio manager is further prompted to suggest an alternative value for the selected strikezone. The alternative value is then communicated back to the product leader. The product leader is then prompted 238 to either accept 240 the alternative value suggested by the portfolio manager or decline 242 the alternative value suggested by the portfolio manager and then suggest 244 a new value. This back and forth process is repeated until the product leader and the portfolio manager agree on a proposed strikezone change for the risk category. Once the product leader and the portfolio manager agree on the proposed strikezone change, the proposed change is communicated to the risk manager.

The risk manager confirms 250 the proposed strikezone change, which has been approved by the product leader and the portfolio manager.

System 10 then determines 252 whether a second customer leader role has been defined within the system. If a second customer leader role has been defined, system 10 directs the proposed change from the risk manager to the direct customer leader and the broker customer leader. The direct customer leader is then prompted 254 to confirm or question the proposed strikezone change. The broker customer leader is then prompted 256 to confirm or question the proposed strikezone change. If the direct customer leader and the broker customer leader confirm the proposed strikezone change, the proposed change is submitted 258 as being finally approved.

If, however, a second customer leader role has not been defined, system 10 directs the proposed change from the risk manager to the direct customer leader for confirmation. The direct customer leader is then prompted 260 to confirm or question the proposed strikezone change. If the direct customer leader confirms the proposed strikezone change, the proposed strikezone change is submitted 258 as being finally approved.

In the example embodiment, system 10 enables a strikezone manager to control 270 a workflow of the approval process including monitoring an amount of time elapsed at each stage of the approval process and can act on behalf of any person that may be delaying the approval process. The strikezone manager also receives all notifications of changes and can extract extra reports relating to system performance.

After the proposed strikezone change has been approved, system 10 transmits 274 the approved strikezone change to database 20 (shown in FIG. 1). Once the approved strikezone is saved in database 20, system 10 then performs several automated tasks including at least one of: creating 280 CSV (comma separated values) files for a GUS (Global Underwriting System) database; creating 282 Internet files including creating HTML files using an external template and then publishing a list of all “external” view files to an Internet index; creating 284 Intranet files including creating HTML files using an internal template and then publishing a list of all “internal” view files to an intranet index; and creating 286 PDF files including creating corresponding PDF files for each strikezone, which are saved both within SMS 10 and also on an intranet. In the example embodiment, SMS 10 exports CSV files to the GUS for uploading and mapping into the GUS system. This enables an automatic color-coding of deals to be made once an underwriter enters parameters into GUS. In other words, the CSV files exported to GUS are utilized to assign an approved strikezone from a portfolio level to a deal level.

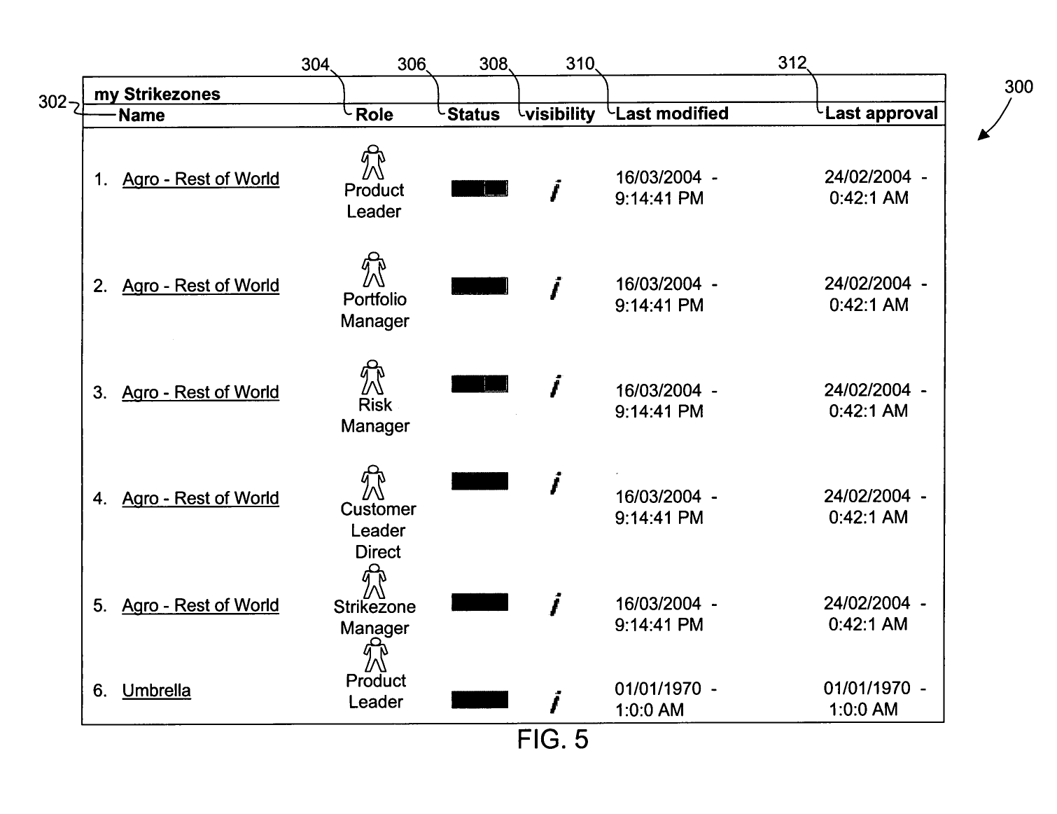

FIG. 5 is an example embodiment of a user interface 300 displaying a my strikezones page within SMS 10 (shown in FIG. 1). In the example embodiment, user interface 300 is displayed after a user logs on to SMS 10. User interface 300 displays an inbox with an overview of all strikezones assigned to the user. In the example embodiment, user interface 300 displays a matter name 302, a role 304 assigned to the user for the matter, a status bar 306, a visibility 308, a last modified entry 310, and a last approved entry 312.

In the example embodiment, much of the information displayed on user interface 300 is color coded to enable a user to more easily understand the status of the matter and whether the user is required to perform a task. For example, status bar 306 is color coded and displays a status of a matter including at least one of waiting, actions to do, nothing to do, and no values indicator.

Role 304 includes at least one of a product leader, a portfolio manager, a risk manager, a customer leader, and a strikezone manager. In the example embodiment, a product leader role is a main role within a product team. The product leader manages strikezone packages. A portfolio manager role is another role within the product team. The portfolio manager oversees and agrees with changes made by the product leader. The portfolio manager is essentially a second set of eyes used to confirm the product leader's product plans and strategies. A risk manager is assigned to each product team. The risk manager role confirms changes made by the product team. A customer leader is a sales leader for both a direct and broker businesses. In the example embodiment, each strikezone can have one or two customer leaders assigned to it. The customer leader confirms that they have seen and understood changes made by the product team and confirmed by the risk manager. A strikezone manager role is assigned to a strikezone initiative leader. The strikezone manager has overall control over the workflow of the system and can act on behalf of any person causing a delay within the system. The strikezone manager also receives all notifications of changes and can extract reports relating to system performance.

User interface 300 is utilized by a user who wishes to edit or work on a given strikezone. The user selects one of the actions to be taken that is displayed on user interface 300. Once the user has completed any action required items, the workflow is moved forward to the next in line, and the user's status bar changes accordingly until the workflow item is closed via a “final approval”.

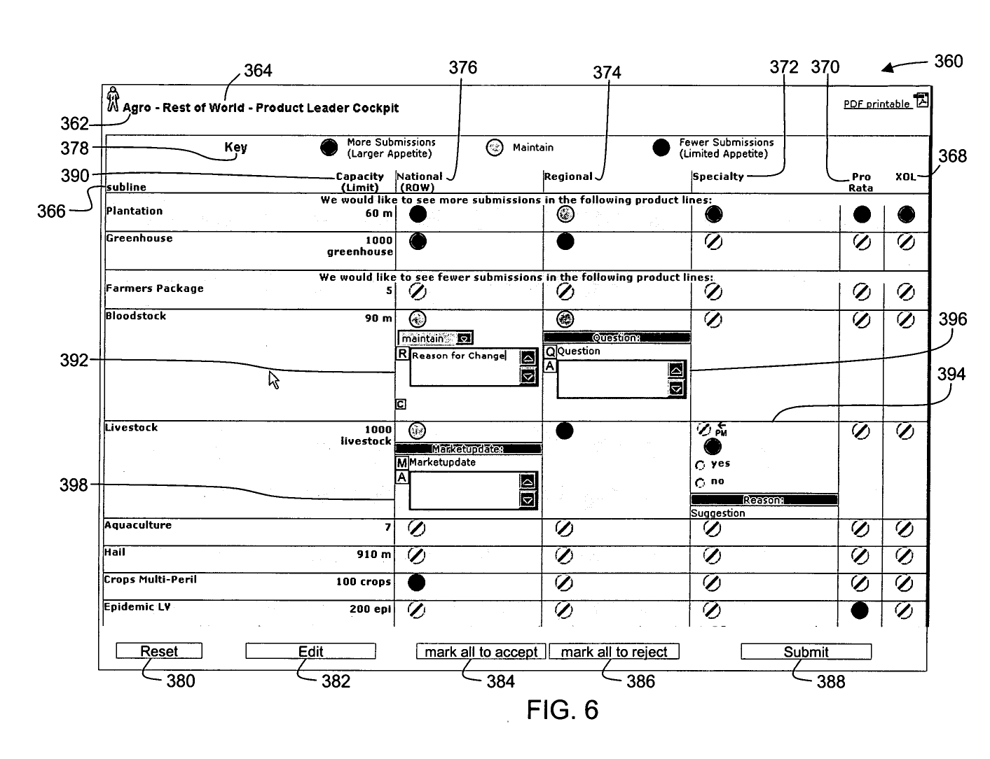

FIG. 6 is an example embodiment of a user interface 360 displaying a product leader actions page within SMS 10 (shown in FIG. 1). User interface 360 is displayed when a user selects a matter displayed on user interface 300 (shown in FIG. 5). In the example embodiment, user interface 360 displays a line of business 362, and a regional segment 364. Lines of business 362 and regional segment 364 are categories that include various insurance products included within an insurer's portfolio. User interface 360 further categorizes these insurance products by displaying at least one of a subline 366, and agreement types. The agreement types include at least one of excess of loss (XOL) 368, pro rata 370, specialty 372, regional 374, and national (Rest of World) 376. Other agreement types may include surplus, working, catastrophic (Cat), per risk/per event, treaty excess liability, and facultative excess liability.

In the example embodiment, user interface 360 also includes a key section 378, a reset button 380, an edit button 382, a mark all to accept button 384, a mark all to deny button 386, a submit button 388, and a capacity limit 390.

In the example embodiment, user interface 360 also displays traffic light values for each subline 366 and agreement type. The traffic light values indicate the current strikezone assigned to the insurance products included within that category. The traffic light is color coded and indicates whether the insurer desires more submissions (larger appetite), fewer submissions (limited appetite), or a maintaining of the current submissions for that particular category. The color coding is indicated by key section 378.

A strikezone indicates a current risk appetite by product line and sublines for an insurer. SMS 10 enables product teams to define their product targets from one underwriting season to the next based on a set of criteria. The “traffic lights” used within SMS 10 are color coded. For example, a green traffic light indicates that the insurer desires more of that particular business, while a red traffic light indicates that the insurer is interested in less of that particular business, and a yellow traffic light indicates that the insurer would like to maintain the current amount that particular business. A traffic light that does not include a color but instead includes an angled line through it indicates that no value has been assigned to that particular insurance product.

To edit an individual traffic light displayed within user interface 360, a product leader clicks on the traffic light to be edited or clicks on edit button 382. By so doing, the user interface is expanded to include drop-downs to be selected from by the product leader. The product leader can then select a new color upon which a reason box 392 appears with an “R” next to it. The product leader then must enter the reasons for the proposed change in the traffic light. The reasons are also saved in the database for audit trail purposes. The product leader submits the changes by clicking submit button 388.

After the product leader submits the proposed strikezone change, SMS 10 communicates the proposed strikezone change to the portfolio manager (PM). If the portfolio manager disagrees with the changes proposed by the product leader (PL), the product leader is notified of the disagreement along with a suggestion by the portfolio manager of what the portfolio manager believes the value of the strikezone should be. The portfolio manager may also make a suggestion without input from the product leader. In both cases, this is done through the workflow of the system and is shown in a decline/accept box 394. The product leader then reviews the changes and reasons provided by the portfolio manager, and either “accepts” or “declines” by using radio buttons shown in decline/accept box 394. The product leader can do this individually for smaller numbers of changes. However, should there be multiple suggestions to review, the product leader has the option to select all to “approve” or all to “decline” by using either mark all to accept button 384 or mark all to deny button 386. Should the product leader approve of suggestions made by the portfolio manager, these items then move on in the workflow (skipping the portfolio manager) to the risk manager. Should the product leader “decline” the value suggested by the portfolio manager, these items then go back to the portfolio manager again with the product leader's changes and reasons for the change. These values go back and forth between the product leader and the portfolio manager until a consensus is reached with respect to the values.

User interface 360 also displays a question box 396. After the portfolio manager approves changes to a strikezone value, these approved changes move forward to the risk manager for “confirmation” only. Should the risk manager, however, have questions to the changes made, the risk manager can send those questions to the product leader by clicking on the traffic light in question, expanding out a text box “Q” for the risk manager to enter these questions into. The questions are sent to the product leader who then can post “answers” to these questions in the available text box “A” below the “Q”. This process goes back and forth between the risk manager and the product leader until the risk manager believes that all of these questions have been answered. The risk manager then “confirms” the changes to the strikezone value.

User interface 360 also displays a market update box 398. After the risk manager “confirms” changes to a strikezone value, the change is then directed to defined customer leaders (CL) for review as well. Similar to the risk manager, the customer leader can review changes and confirm these as such. The customer leader's only direct interaction with the product team's strikezone decisions is to post “market updates” which route back to the product leader for review. The customer leader submits a market update for review by the product leader by clicking on the traffic light in question to expand out a text box “M” to enter in the requested market update. The product leader can then “answer” to this market update in the available text box “A” below the “M”. This process is repeated until the customer leader is satisfied with the information provided by the product leader. When the customer leader submits the proposed strikezone value, the proposed strikezone value has then received “final approval”.

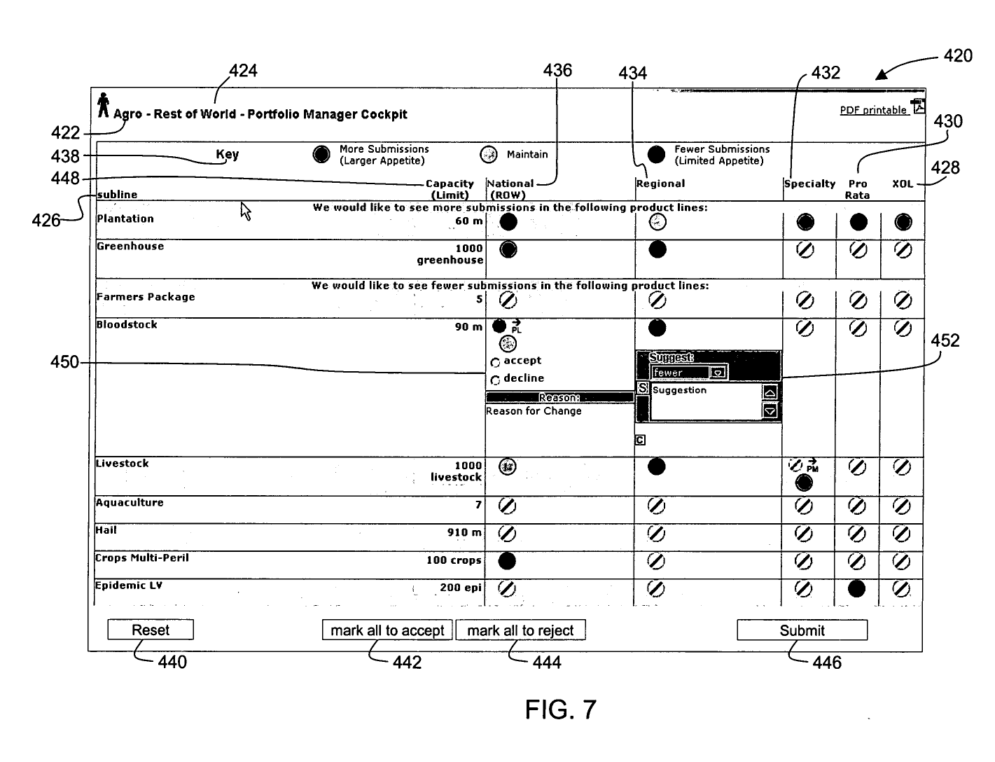

FIG. 7 is an example embodiment of a user interface 420 displaying a portfolio manager page within SMS 10 (shown in FIG. 1). User interface 420 displays a line of business 422, and a regional segment 424. In the example embodiment, user interface 420 also displays information by risk categories including at least one of a subline 426, and agreement types. The agreement types displayed include excess of loss (XOL) 428, pro rata 430, specialty 432, regional 434, and national (Rest of World) 436. A customer segment includes specialty 432, regional 434, and national (Rest of World) 436. User interface 420 also includes a key section 438, a reset button 440, a mark all to accept button 442, a mark all to reject button 444, a submit button 446, and a capacity limit 448.

As also shown in user interface 360 (shown in FIG. 6), traffic light values are displayed on user interface 420 by subline and agreement type. In the example embodiment, the portfolio manager receives notification as soon as the product leader has made any changes to a given strikezone. The portfolio manager can review these changes proposed by the product leader by clicking on the strikezone in question within the portfolio manager's home page, which is prioritized with an “actions to do” status bar, or directly via a link that the portfolio manager receives in an email notification.

In the example embodiment, user interface 420 includes an “accept or decline” value box 450. Accept or decline value box 450 indicates the changes made by the product leader to the strikezone and indicates the old value of the strikezone. In the example embodiment, the old value of the strikezone is shown as a smaller circle while the new value set by the product leader is a larger circle. The reason for the change is also immediately visible under a “reason” section of accept or decline value box 450. The portfolio manager can either “accept” or “decline” changes by selecting the appropriate radio button. However, should there be multiple suggestions to review, the portfolio manager has the option to select all to “approve” or all to “decline” by using mark all to accept button 442 or mark all to reject button 444. To submit answers, the portfolio manager clicks submit button 446.

User interface 420 also displays a suggestion box 452. Similar to the action “edit traffic light values” for the product leader, the portfolio manager can also make an unprompted suggestion to change a traffic light value. To do so, the portfolio manager clicks on the traffic light in question or clicks on an edit button to expand out the interface to include a drop-down menu that prompts the portfolio manager to select a suggested value. The portfolio manager is then prompted to enter reasons for the change in the text box marked “R”. The portfolio manager submits this information by clicking the submit button 446, which then submits the change to the product leader for review.

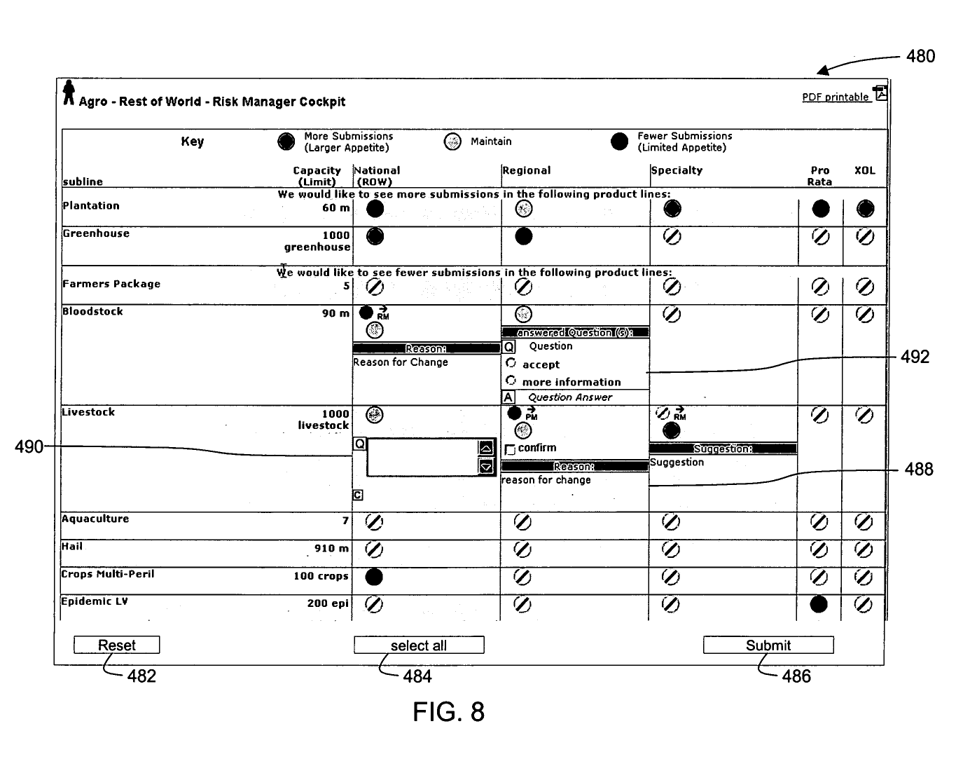

FIG. 8 is an example embodiment of a user interface 480 displaying a risk manager page within SMS 10 (shown in FIG. 1). In the example embodiment, user interface 480 includes a reset button 482, a select all button 484, and a submit button 486. After the portfolio manager has approved changes to a given strikezone, the risk manager receives a notification of these approved changes. The notification is displayed in user interface 480. User interface 480 includes a confirmation box 488 that enables a risk manager to “confirm” changes agreed upon by the product team (i.e., the product leader and the portfolio manager). The risk manager confirms changes by selecting a “confirm” checkbox next to the changes in question. If there are multiple changes that the risk manager would like to confirm, the risk manager can do so by selecting select all button 484. Once the risk manager confirms the changes, the risk manager clicks on submit button 486 to move the workflow forward and remove the action from the risk manager's inbox.

User interface 480 also includes a question box 490. If the risk manager has questions to any changes proposed by the product team, the risk manager can ask those questions by clicking on the traffic light value in question. This expands out a text box “Q” for the risk manager to enter the corresponding question in. This question is then submitted back to the product leader via an email notification such that the product leader can then answer the question submitted by the risk manager.

User interface 480 also includes an accept answer box 492. In the example embodiment, once the product leader has answered the risk manager's question, the risk manager receives an email notification. The risk manager can review the answers provided by the product leader and can either confirm that the answers satisfy the questions submitted or the risk manager can require more information from the product leader. This process goes back and forth between the product leader and the risk manager until the risk manager “accepts” that all questions have been answered. The risk manager does this by clicking an accept radio button included within accept answer box 492. The risk manager then clicks submit button 486 to move the workflow forward. The questions and answers are saved in the database and this action item is removed from the risk manager's interface.

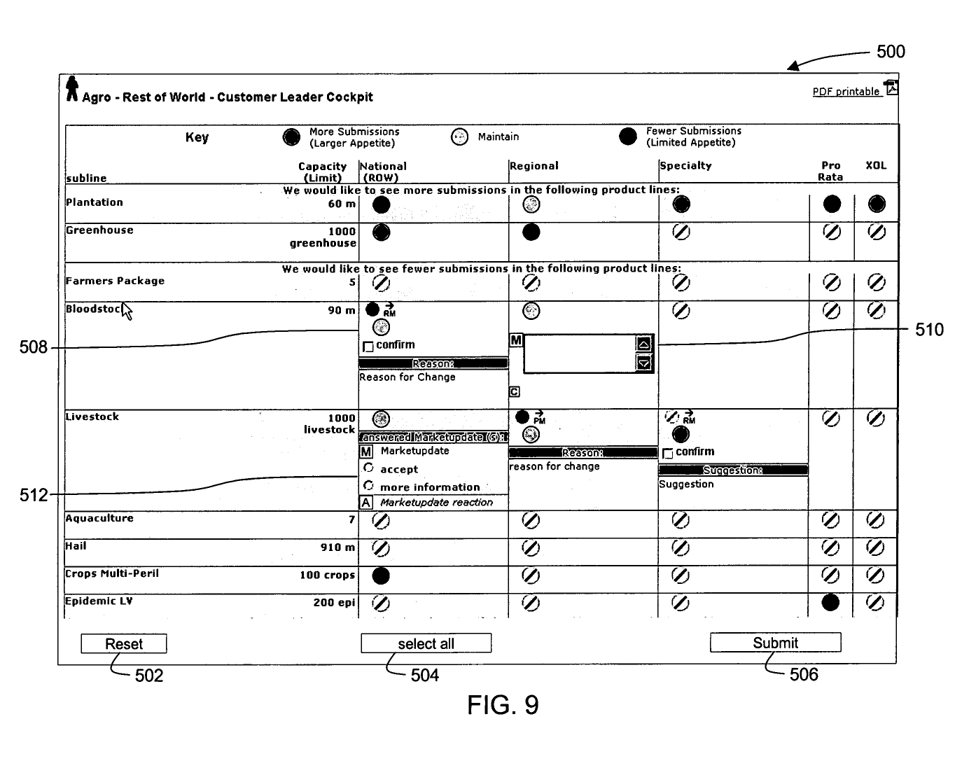

FIG. 9 is an example embodiment of a user interface 500 displaying a customer leader internal values page within SMS 10 (showed in FIG. 1). In the example embodiment, user interface 500 includes a reset button 502, a select all button 504, and a submit button 506. Once the risk manager has confirmed changes to a given strikezone, the customer leader receives notification of the confirmed changes. User interface 500 provides such notification. The customer leader can review these confirmed changes by clicking on the strikezone in question in the customer leader's home page, which is prioritized with an “actions to do” status bar, or directly via a link that the customer leader receives in an email notification.

User interface 500 includes a confirm changes box 508. Confirm changes box 508 enables a customer leader to “confirm” that he has seen the changes proposed by the product team for a given strikezone. The customer leader confirms these changes by selecting the “confirm” check box displayed within confirm changes box 508. Should there be multiple changes that the customer leader would like to confirm, the customer leader can do so by using select all button 504. The customer leader submits these confirmations by clicking submit button 506.

User interface 500 also includes a market update box 510. In the example embodiment, the only interaction between the customer leader and the product team is through market updates submitted by the customer leader to the product team. The customer leader provides market updates that are appropriate for the product team to be aware of and which might affect the way the product team views their portfolio appetite. The customer leader submits these market updates by clicking on the appropriate strikezone to expand out a text box marked “M”. The customer leader then enters the market update and then clicks submit button 506 to submit the market update to the product leader for review and answer.

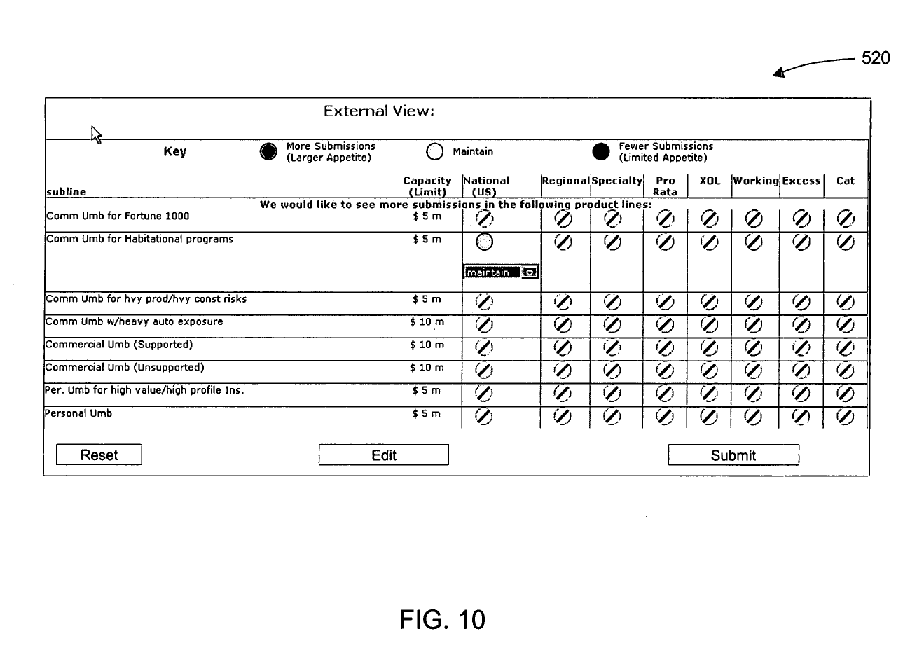

FIG. 10 is an example embodiment of a user interface 520 displaying a customer leader external values page within SMS 10 (shown in FIG. 1). The example embodiment, user interface 520 includes a subline column, a capacity limit column, a national (U.S.) column, a regional column, a specialty column, a pro rata column, an XOL (excess of loss) column, a working column, an excess column, and a Cat (catastrophic) column.

In the example embodiment, if an “external view” is defined in a given strikezone, a broker customer leader has the ability to manipulate this interface as necessary for external use over a wide area network. The wide area network may include, for example, the Internet. The broker customer leader has a “double” view of each strikezone. The top view is the internal view that the product team sets and where the broker customer leader “confirms” any new changes the product team makes. The lower view in the interface is the “external” view, which the system publishes for a wide area network such as the Internet. The broker customer leader has the ability to manipulate these values as necessary to suit external viewing. The broker customer leader performs this task in a fashion similar to the action “edit traffic light values” for the product leader. The broker customer leader must only click on the traffic light in question or use the edit button to expand out the interface to include simple drop-down menus for selecting appropriate external values.

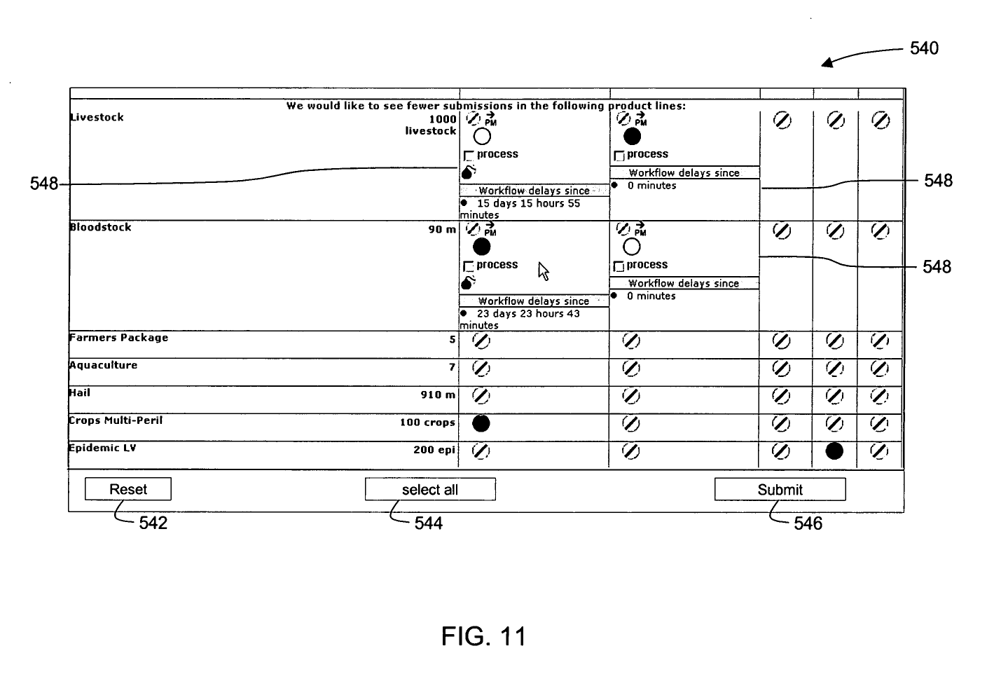

FIG. 11 is an example embodiment of a user interface 540 displaying a strikezone manager page within SMS 10 (shown in FIG. 1). In the example embodiment, user interface 540 displays a reset button 542, a select all button 544, and a submit button 546. In the example embodiment, once both customer leaders have confirmed changes (i.e., final approval) to a given strikezone, the strikezone manager receives notification. The strikezone manager can then review these changes by clicking on the strikezone in question within the strikezone manager's homepage, which is prioritized with an “actions to do” status bar, or directly via a link the strikezone manager receives in an email notification.

User interface 540 also includes at least one process box 548 that enables the strikezone manager to monitor the entire workflow of SMS 10. The strikezone manager is a “behind the scenes” monitor of the entire workflow for each strikezone. At any time, the strikezone manager can review the exact status of any change still within a workflow, and determine whether there are any significant delays. Should a change be delayed in the workflow longer than 5 days, a “bomb” symbol appears next to it as shown in process box 548. In an alternative embodiment, a symbol other than a “bomb” is used to show that a strikezone change has been delayed in the workflow longer than 5 days. This strikezone is then given priority in the strikezone manager's view. The strikezone manager can then act on behalf of any role within a strikezone by clicking the “process” box next to a delayed item. Should multiple changes be delayed, the strikezone manager can use select all button 544 to process all such matters. To submit any changes, the strikezone manager must only click on submit button 546, which then moves all selected items forward one step within the defined workflow. Email notifications are sent out indicating that the strikezone manager acted on behalf of the normal user.

SMS 10 also includes a comments display page (not shown) that can be opened by clicking on a small “c” symbol behind each traffic light. The comments box provides an overview of all of the dialogue between that value in terms of reasons for change and declines between the product leader and the portfolio manager, reasons for suggested changes the portfolio manager submits to the product leader and any associated “declines” the product leader makes to these, questions asked by the risk manager and answers thereto, and any market updates submitted by the customer teams. The comments page may also include any prior history of previous dialogue from previous changes the product team has made with respect to that traffic light. The comments page also includes a date stamp for when each entry was made with respect to that traffic light.

A main menu appears on the home page of each user and the items listed on the main menu depends on the user's role definition. For example, the main menu may include at least one of the following commands: my strikezones, add strikezone, edit strikezone, major lines/sublines, territories, agreement types, customer segments, reports, data drill, documentation, help, and contact us. In the example embodiment only the system administrator would see add strikezone and edit strikezone.

The strikezone administrator can add a strikezone at any time by clicking on the add strikezone command in the main menu. The strikezone administrator then enters the general data about the new strikezone. The strikezone administrator may also edit an existing strikezone by selecting the edit strikezone command on the main menu. The strikezone administrator can edit a strikezone using drop-down menus or by entering text into text fields. The strikezone administrator can drill down into a strikezone and can edit the settings provided for that strikezone. For example, the strikezone administrator can edit strikezone responsibilities, customer segments, agreement types, and sublines. In editing responsibilities, the strikezone administrator can assign or delete a role for a given strikezone. To edit assigned customer segments, the strikezone administrator clicks or unclicks customer segments that are displayed on a user interface. Similarly, the customer administrator can edit agreement types and sublines for a given strikezone. Sublines may include, for example, at least one of aircraft liability (non-owned and charter), auto, BBB (Bankers' Blanket Bonds), CAR (Contractors' All Risk), commercial crime/fidelity, completed operations, D&O/EPLI (Directors and Officers/Employment Practice Liability Insurance), EIL (Environmental Impairment Liability), employer's liability, and FI (Financial Institutions).

The strikezone administrator may also edit major lines of business (MLOB) used within SMS 10. MLOB may include, for example, at least one of property, casualty, and specialty. To get an overview of the existing MLOB's/sublines entered in SMS 10, the strikezone administrator selects “market update” from the main menu. The strikezone administrator may add a new MLOB by entering the details of the new MLOB into a template that includes a name field for the name of the MLOB, and a GUS-ID field where the corresponding GUS-ID tag number is entered. GUS is a Global Underwriting System. In addition, the strikezone administrator can edit an existing MLOB by clicking on the MLOB in question and entering the new information. Similarly, sublines can also be entered by the strikezone administrator.

In the example embodiment, the strikezone administrator can also edit territories, legacy definitions, agreement types, and customer segments included within SMS 10.

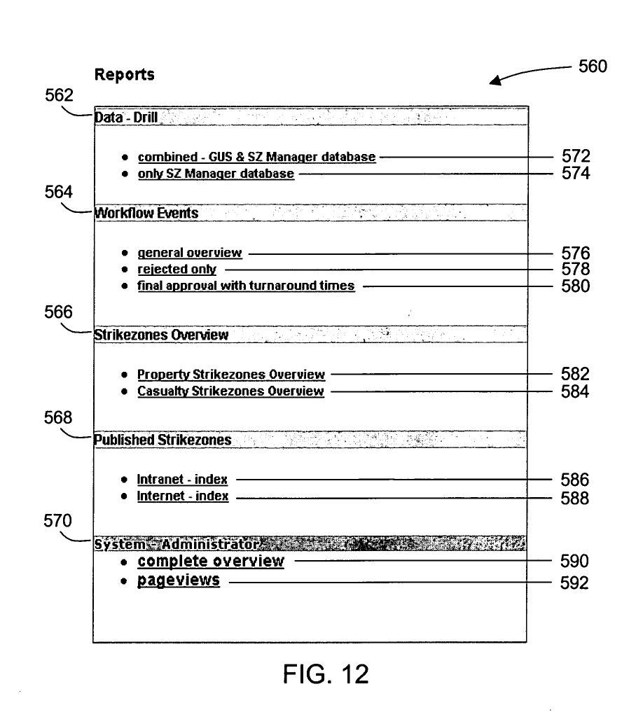

FIG. 12 is an example embodiment of a user interface 560 displaying a reports overview page within SMS 10 (shown in FIG. 1). User interface 560 includes a data drill section 562, a workflow events section 564, a strikezones overview section 566, a published strikezones section 568, and a system administrator section 570. Data drill section 562 includes a combined—GUS and SZ manager database 572, and a only SZ manager database 574. Workflow events section 564 includes a general overview 576, a rejected only 578, and a final approval with turnaround times 580. Strikezones overview section 566 includes a property strikezones overview 582 and a casualty strikezones overview 584. Published strikezones section 568 includes an Intranet—Index 586, and a Internet—Index 588. System administrator section 570 includes a complete overview 590, and a page views 592.

In the example embodiment, by selecting “reports” in the main menu, a user arrives at user interface 560 detailing all reports currently available in SMS 10. Data drill section 562 is a customizable report functionality whereby the user defines what they would like to see by selecting desired criteria from drop-down menus that are provided.

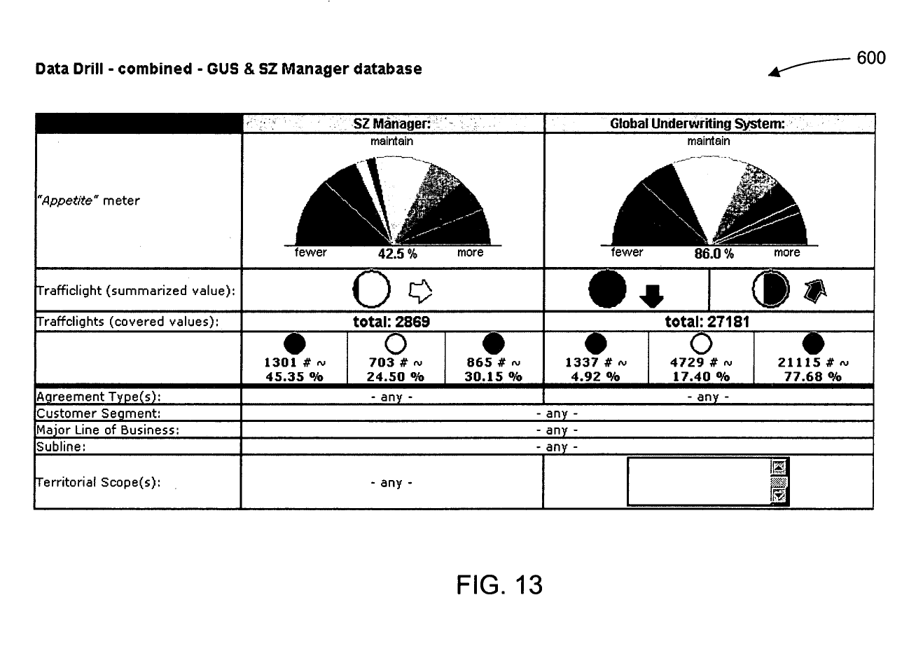

FIG. 13 is an example embodiment of a user interface 600 displaying a data drill combined page within SMS 10 (shown in FIG. 1). The combined data drill shows an overview of selected criteria as defined by the user for both SMS 10 and also for the Global Underwriting System (GUS). The combined data drill includes a side-by-side view of the insurers projected risk appetite versus the actuals taken from the GUS. Data filters are available for the user to select all criteria available in the strikezone interfaces (i.e., MLOB, subline, agreement type, territorial scope, and customer segmentation).

User interface 600 is an example of what a report looks like for the combined data drill. In the example embodiment, no data filters were applied so the system shows an overview of all data points available. The appetite meter shows where the insurers risk appetite lies on a scale of 0 to 100 for all available traffic light data meeting the defined criteria. The pointer moves along the scale once specific data filters are selected. User interface 600 includes an SZ Manager report and a GUS report.

In the example embodiment, the traffic light (summarized value) row shows two types of data in the strikezone manager report, the system creates a traffic light based on the speedometer readout (i.e., showing an exact gradient mix of risk appetite); and an arrow next to the traffic light is a risk indicator showing the tendency wherein in this case the arrow is moving slightly downwards to show that the insurer is not at 50 on the scale but is at a slightly lower value. In the GUS report, the traffic light row includes an entry showing an exact averaged readout of the data, and an entry showing the worst-case scenario from that data.

The traffic lights (covered values) row indicates how many data points are feeding the readout. Additionally, user interface 600 displays the exact data filters that have been selected for the data drill.

Data drill section 562 (shown in FIG. 12) includes only SZ manager database 574. The data drill for the only strikezone manager database provides the same read out and functionality as the combined view, but only utilizes data from SMS 10.

Workflow events section 564 (shown in FIG. 12) includes a general overview 576. General overview 576 provides overviews of all defined strikezones in terms of changes made, turnaround time (TAT), and rejected only on a defined time scale and by individual strikezone. To view a general overview, the user must first select the strikezone they wish to see more information on and click a submit button. The user then defines the time period they wish to see data on via a “select quarter” pull-down, and then they select the sublines they wish to see. Multiple sublines can be selected using a strg command. A “preferences” section allows the user to further filter the data by defining whether they wish to view “all changes”, “rejected” or “final approval with TAT”. A small calendar symbol allows the user to select a specific time period outside the pre-defined “quarter” selections in the drop-down. Once the user has selected the filters, the user then clicks a submit button to run the report. Should the user wish to see “all changes”, the report will display all changes for a selected subline.

The rejected only report is similar to the general overview report. However, the rejected only report shows only changes that were rejected at some point during the workflow.

The final approval report provides a user with a simple overview of any and all changes saved in the strikezone database for the given traffic light. If there were more than one “final approval” saved for a selected traffic light, the user can see the amount of time between one change and the next to better understand how often the teams are using the SMS tool.

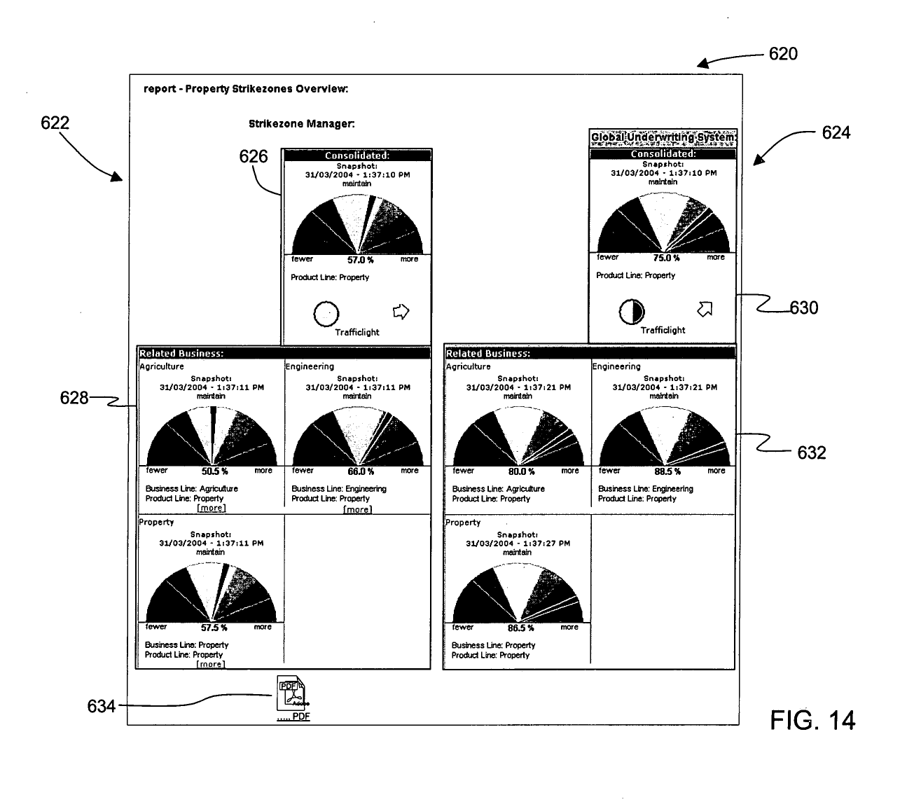

FIG. 14 is an example embodiment of an user interface 620 displaying a property strikezone overview report page within SMS 10 (shown in FIG. 1). In the example embodiment, user interface 620 includes a strikezone manager overview 622 and a global underwriting system (GUS) overview 624. Strikezone manager overview 622 includes a consolidated view 626 and related business views 628. GUS overview 624 includes a consolidated view 630, and related business views 632.

The property and casualty overview is another report that is available to users of SMS 10. This report is an automatic side-by-side report view generated based on all data associated with either “property” or “casualty” product lines. Strikezone manager overview 622 details all internal strikezone manager data saved in the system, while GUS overview 624 details all associated GUS data received via the import file.

The consolidated views are views of all associated traffic light data points. The data included in the consolidated views is further broken down and displayed in the related business views. User interface 620 also includes a PDF icon 634, which enables a user to generate an automatic PDF file based on the views displayed within user interface 620.

In the example embodiment, as soon as strikezones are saved in SMS 10 via final approval, an Intranet and Internet index are generated. The published indexes are available for all users to see. The Intranet Index is a list of all published strikezones housed in an internal template within SMS 10. The Intranet Index lists the files as HTML files. These HTML files are then linked to a strikezone Intranet page. Anyone within the business can access the Intranet page to view the most current strikezone values and packages. This list is updated anytime a change is made to any given strikezone. This ensures data integrity and ensured that all users are working off of the same information.

SMS 10 also generates an Internet Index. The same list is published for the Internet from the saved strikezones. However, the Internet Index uses an external template so that an external audience can view this data.

A complete overview report is a list of all saved strikezones and their associated definitions for MLOB, subline, territorial scope, visibility, roles and responsibilities, customer segments, and agreement types. The strikezone administrator also has the ability to view system statistics showing how many page views in the last 24 hours, 60 minutes and 1 minute respectively as well as overall. This report also shows details as to page load times and which pages are being looked at by users.

In the example embodiment, once a change to a traffic light is saved via “final approval”, SMS 10 performs at least the following automated tasks:
(1) creating CSV files for the global underwriting system (GUS) 120 (shown in FIG. 3); (2) creating Internet files; (3) creating Intranet files; and (4) creating PDF files.

With respect to creating CSV files for GUS 120, the strikezone manager exports CSV files to GUS 120 for uploading and mapping into the GUS system. This enables an automatic color coding of deals to be made once an underwriter enters parameters into GUS 120. In the example embodiment, one CSV file is for treaty related insurance, one for facultative related insurance, and one for natural catastrophe related insurance. In an alternative embodiment, SMS 10 and GUS 120 are directly linked such that information is exchanged between SMS 10 and GUS 120 without having to first create CSV files for GUS 120. In other words, SMS 10 would automatically transmit information to GUS 120 regarding updated strikezone parameters, and would automatically receive information from GUS 120 on contracts and their strikezone colors.

With respect to creating Internet files, SMS 10 creates HTML files using an external template and then publishes a list of all external view files to an Internet index.

With respect to creating Intranet files, SMS 10 creates HTML files using an internal template and then publishes a list of all internal view files to an Intranet index.

With respect to creating PDF files, SMS 10 creates corresponding PDF files for each strikezone, which are saved both within the strikezone manager system and also on the Intranet.

SMS collects, tracks, displays, and disseminates near-real time information. In addition, SMS permits various approved users within an insurer to share information. SMS therefore better enables an insurer to manage a portfolio of insurance products. More specifically, SMS better enables a user to analyze data relating to the insurance products included within a portfolio, segment the insurance products included within the portfolio into predefined risk categories, analyze market trends for at least a segment of an insurance industry, and recommend a strikezone for each risk category based on the portfolio analysis and the market trends analysis wherein the strikezone indicates whether an insurer will increase, decrease, or maintain an amount of business currently being solicited from potential insureds for the corresponding risk category. SMS also enables a user to submit the recommended strikezone for each risk category to an approval process, store the approved strikezone in a database, and display the approved strikezone for each risk category on a computer system to enable the user to solicit business for the insurer based on the portfolio analysis and the market trends analysis.

After the proposed strikezone has been “finally approved”, the SMS transmits the approved change to the database SMS then performs several automated tasks including at least one of: creating CSV (comma separated values) files for a GUS (Global Underwriting System), creating Internet files including creating HTML files using an external template and then publishing a list of all “external” view files to an Internet index, creating Intranet files including creating HTML files using an internal template and then publishing a list of all “internal” view files to an intranet index, and creating PDF files including creating corresponding PDF files for each strikezone which are saved both within SMS and also on an intranet. The CSV files are exported from SMS to GUS for uploading and mapping into the GUS system. This enables an automatic color-coding of deals to be made once an underwriter enters parameters into GUS.

While the invention has been described in terms of various specific embodiments, those skilled in the art will recognize that the invention can be practiced with modification within the spirit and scope of the claims.

1. A method for managing a portfolio of insurance products using a computer system coupled to a database, the database having data relating to insurance products stored therein, the data relating to at least one of premiums, commissions, insurance policies, reinsurance policies, contracts, policy limits, claims, and losses, said method comprising:
analyzing data stored within the database using the computer system including segmenting the insurance products included within the portfolio into predefined risk categories;
analyzing market trends for at least a segment of an insurance industry; and
recommending a sales indicator for each risk category based on the portfolio analysis and the market trends analysis, the sales indicator indicates whether an insurer will increase, decrease, or maintain an amount of business currently being solicited from potential insureds for the corresponding risk category.

2. A method in accordance with claim 1 further comprising:
approving by the insurer the recommended sales indicator for each risk category;
storing the approved sales indicators in the database; and
displaying the approved sales indicators for each risk category on the computer system to enable a user to solicit business for the insurer based on the portfolio analysis and the market trends analysis.

3. A method in accordance with claim 2 wherein the computer system is in communication with an underwriting computer system, the method further comprising:
creating at the computer system a data file representing an approved sales indicator including data relating to the risk category corresponding to the approved sales indicator;
exporting the data file from the computer system to the underwriting computer system;
mapping the data file at the underwriting computer system; and
utilizing the mapped data file to assign the approved sales indicator for the risk category to at least one insurance contract included within the underwriting computer system.

4. A method in accordance with claim 2 wherein storing the approved sales indicators in the database further comprises:
automatically creating data files representing each approved sales indicator for uploading to an underwriting computer system;
automatically creating an internal web showcase for an intranet for each approved sales indicator in an appropriate format and template;
automatically creating an external web showcase for the Internet for each approved sales indicator in an appropriate format and template; and
automatically creating a downloaded file showing each approved sales indicator and corresponding risk category for printing purposes.

5. A method in accordance with claim 2 wherein approving by the insurer the recommended sales indicator for each risk category further comprises:
accessing a sales indicator for a selected risk category by a product leader for the insurer;
prompting the product leader to propose updating the sales indicator for the selected risk category, the proposed updated sales indicator includes a proposal to at least one of change and maintain the selected sales indicator, and a reason for updating the sales indicator; and
communicating the proposed updated sales indicator from the product leader to a portfolio manager for the insurer.

6. A method in accordance with claim 5 wherein approving by the insurer the recommended sales indicator for each risk category further comprises:
accessing by the portfolio manager the updated sales indicator proposed by the product leader;
prompting the portfolio manager to accept or decline the updated sales indictor proposed by the product leader; and
communicating, if declined by the portfolio manager, the updated sales indicator proposed by the product leader to the product leader for further review until the product leader and the portfolio manager agree on the proposed updated sales indicator for the selected risk category.

7. A method in accordance with claim 6 wherein approving by the insurer the recommended sales indicator for each risk category further comprises:
communicating the proposed updated sales indicator approved by the product leader and the portfolio manager to a risk manager for further review;
prompting the risk manager to confirm or question the proposed updated sales indicator; and
communicating, if questioned by the risk manager, the proposed updated sales indicator including at least one question submitted by the risk manager to the product leader such that the product leader can respond to the at least one submitted question.

8. A method in accordance with claim 7 wherein approving by the insurer the recommended sales indicator for each risk category further comprises:
communicating the proposed updated sales indicator approved by the product leader, the portfolio manager, and the risk manager to a customer leader for further review;
prompting the customer leader to confirm or request a market update from the product leader for the proposed updated sales indicator; and
communicating a market update from the customer leader to the product leader such that the product leader can respond to the market update.

9. A method in accordance with claim 8 wherein approving by the insurer the recommended sales indicator for each risk category further comprises recording the approved sales indicator for the selected risk category in the database after the proposed updated sales indicator for the selected risk category has been approved by the product leader, the portfolio manager, the risk manager, and the customer leader.

10. A method in accordance with claim 2 wherein approving by the insurer the recommended sales indicator for each risk category further comprises storing in the database a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

11. A method in accordance with claim 2 wherein approving by the insurer the recommended sales indicator for each risk category further comprises enabling a system manager to monitor the approval process of each recommended risk-level indicator including an amount of time elapsed at each stage of the approval process.

12. A method in accordance with claim 2 wherein displaying the approved sales indicators for each risk category further comprises displaying on the computer system a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

13. A method in accordance with claim 2 wherein displaying the approved sales indicators for each risk category further comprises displaying on the computer system a capacity limit for each risk category.

14. A method in accordance with claim 2 further comprising enabling a user to generate a plurality of reports showing the approved sales indicators for each risk category including at least one of customizable reports, workflow events reports, strikezones overview reports, published strikezones reports, and system reports.

15. A method in accordance with claim 2 wherein analyzing data stored within the database further comprises segmenting the insurance products included within the portfolio into customer segments including at least one of global, national (U.S.), national (Rest of World), none, regional, and specialty.

16. A method in accordance with claim 2 wherein analyzing data stored within the database further comprises segmenting the insurance products included within the portfolio by agreement types including at least one of none, excess of loss (XOL), pro-rata, surplus, working, excess, catastrophic (Cat), per risk/per event, treaty excess liability, and facultative excess liability.

17. A method in accordance with claim 2 wherein analyzing data stored within the database further comprises segmenting the insurance products included within the portfolio into at least one of major lines of business and regions.

18. A method in accordance with claim 2 wherein the computer system is a server system, and said method further comprises connecting a client system and the server system via a network that includes one of a wide area network, a local area network, an intranet and the Internet.

19. A method for managing a portfolio of reinsurance products using a computer system coupled to a database, the computer system in communication with an underwriting computer system, the database having data relating to reinsurance products stored therein, the data relating to at least one of premiums, commissions, insurance policies, reinsurance policies, contracts, policy limits, claims, and losses, said method comprising:
analyzing data stored within the database using the computer system including segmenting the reinsurance products included within the portfolio into predefined risk categories including major lines of business, sublines, customer segments, regional segments, and agreement types;
analyzing market trends for at least a segment of an insurance and reinsurance industry;
recommending a sales indicator for each risk category based on the portfolio analysis and the market trends analysis, the sales indicator indicates whether a reinsurer will increase, decrease, or maintain an amount of business currently being solicited from potential insureds for the corresponding risk category;
approving by the reinsurer the recommended sales indicator for each risk category;
storing the approved sales indicators in the database;
displaying the approved sales indicators for each risk category on the computer system;
creating at the computer system a data file representing an approved sales indicator including data relating to the risk category corresponding to the approved sales indicator;
exporting the data file from the computer system to the underwriting computer system;
mapping the data file at the underwriting computer system; and
utilizing the mapped data file to assign the approved sales indicator for the risk category to at least one insurance contract included within the underwriting computer system.

20. A network-based system for managing a portfolio of insurance products, said system comprising:
a database for storing data relating to insurance products, the data relating to at least one of premiums, commissions, insurance policies, reinsurance policies, contracts, policy limits, claims, and losses; and
a first computer system configured to be coupled to said database, said first computer system further configured to:
store data in said database;
analyze the data including segmenting the insurance products included within the portfolio into predefined risk categories;
analyze market trends for at least a segment of an insurance industry; and
prompt a user to recommend a sales indicator for each risk category based on the portfolio analysis and the market trends analysis, the sales indicator indicates whether an insurer will increase, decrease, or maintain an amount of business currently being solicited from potential insureds for the corresponding risk category.

21. A system in accordance with claim 20 wherein said first computer system is further configured to:
transmit the recommended sales indicators for each risk category to an approval process;
store the approved sales indicators in said database; and
display the approved sales indicators for each risk category to enable a user to solicit business for the insurer based on the portfolio analysis and the market trends analysis.

22. A system in accordance with claim 21 further comprising an underwriting computer system in communication with said first computer system, said first computer system is further configured to:
create a data file representing an approved sales indicator including data relating to the risk category corresponding to the approved sales indicator; and
export the data file to the underwriting computer system for assigning the approved sales indicator for the risk category to at least one insurance contract included within the underwriting computer system.

23. A system in accordance with claim 21 wherein said first computer system is further configured to:
automatically create data files representing each approved sales indicator for uploading to an underwriting computer system;
automatically create an internal web showcase for an intranet for each approved sales indicator in an appropriate format and template;
automatically create an external web showcase for the Internet for each approved sales indicator in an appropriate format and template; and
automatically create a downloaded file showing each approved sales indicator and corresponding risk category for printing purposes.

24. A system in accordance with claim 21 further comprising a remote computer system in communication with said first computer system, said first computer system is further configured to transmit the recommended sales indicator for each risk category to said remote computer system for the approval process.

25. A system in accordance with claim 21 wherein said first computer system is further configured to:
prompt a product leader to propose updating a sales indicator for a selected risk category, the proposed updated sales indicator includes a proposal to at least one of change and maintain the sales indicator, and a reason for updating the sales indicator; and
communicate the proposed updated sales indicator from the product leader to a portfolio manager for the insurer.

26. A system in accordance with claim 25 wherein said first computer system is further configured to:
enable a portfolio manager for the insurer to access the updated sales indicator proposed by the product leader;
prompt the portfolio manager to accept or decline the updated sales indicator proposed by the product leader; and
communicate, if declined by the portfolio manager, the updated sales indicator proposed by the product leader to the product leader for further review until the product leader and the portfolio manager agree on the proposed updated sales indicator for the selected risk category.

27. A system in accordance with claim 26 wherein said first computer system is further configured to:
communicate the proposed updated sales indicator approved by the product leader and the portfolio manager to a risk manager for further review;
prompt the risk manager to confirm or question the proposed updated sales indicator; and
communicate, if questioned by the risk manager, the proposed updated sales indicator including at least one question submitted by the risk manager to the product leader such that the product leader can respond to the at least one submitted question.

28. A system in accordance with claim 27 wherein said first computer system is further configured to:
communicate the proposed updated sales indicator approved by the product leader, the portfolio manager, and the risk manager to a customer leader for further review;
prompt the customer leader to confirm or provide a market update to the product leader for the proposed updated sales indicator; and
communicate a market update from the customer leader to the product leader such that the product leader can respond to the market update.

29. A system in accordance with claim 28 wherein said first computer system is further configured to record the approved sales indicator for the selected risk category in said database after the proposed updated sales indicator for the selected risk category has been approved by the product leader, the portfolio manager, the risk manager, and the customer leader.

30. A system in accordance with claim 21 wherein said first computer system is further configured to store in said database a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

31. A system in accordance with claim 21 wherein said first computer system is further configured to enable a system manager to monitor the approval process of each recommended sales indicator including an amount of time elapsed at each stage of the approval process.

32. A system in accordance with claim 21 wherein said first computer system is further configured to display a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

33. A system in accordance with claim 21 wherein said first computer system is further configured to display a capacity limit for each risk category.

34. A system in accordance with claim 21 wherein said first computer system is further configured to segment the insurance products included within the portfolio into customer segments including at least one of global, national, (U.S.), national (Rest of World), none, regional, and specialty.

35. A system in accordance with claim 21 wherein said first computer system is further configured to segment the insurance products included within the portfolio by agreement types including at least one of none, excess of loss (XOL), pro-rata, surplus, working, excess, catastrophic (Cat), per risk/per event, treaty excess liability, and facultative excess liability.

36. A system in accordance with claim 21 wherein said first computer system is further configured to segment the insurance products included within the portfolio into at least one of major lines of business and regions.

37. A system in accordance with claim 21 wherein said first computer system is further configured to generate a plurality of reports showing the approved risk-level indicators for each risk category including at least one of customizable reports, workflow events reports, strikezones overview reports, published strikezones reports, and system reports.

38. A system in accordance with claim 21 wherein said first computer system is coupled to a remote computer system and said database using a network including one of a wide area network, a local area network, an intranet and the Internet.

39. A network-based system for managing a portfolio of reinsurance products, said system comprising:
an underwriting computer system;
a database for storing data relating to reinsurance products, the data relating to at least one of premiums, commissions, insurance policies, reinsurance policies, contracts, policy limits, claims, and losses; and
a computer system configured to be coupled to said database and said underwriting computer system, said computer system further configured to:
store data in said database;
analyze the data including segmenting the reinsurance products included within the portfolio into predefined risk categories including major lines of business, sublines, customer segments, regional segments, and agreement types;
analyze market trends for at least a segment of an insurance and reinsurance industry;
prompt a user to recommend a sales indicator for each risk category based on the portfolio analysis and the market trends analysis, the sales indicator indicates whether a reinsurer will increase, decrease, or maintain an amount of business currently being solicited from potential insureds for the corresponding risk category;
transmit the recommended sales indicators for each risk category to an approval process;
store the approved sales indicators in said database;
display the approved sales indicators for each risk category;
create a data file representing an approved sales indicator including data relating to the risk category corresponding to the approved sales indicator; and
export the data file to the underwriting computer system for assigning the approved sales indicator for the risk category to at least one insurance contract included within the underwriting computer system.

40. A computer program embodied on a computer readable medium for managing a portfolio of insurance products, said program comprising at least one code segment that:
receives data relating to insurance products, the data relating to at least one of premiums, commissions, insurance policies, reinsurance policies, contracts, policy limits, claims, and losses;
maintains a database by adding, deleting and updating data;
analyzes the data including segmenting the insurance products included within the portfolio into predefined risk categories;
analyzes market trends for at least one segment of an insurance industry; and
prompts a user to recommend a sales indicator for each risk category based on the portfolio analysis and the market trends analysis, the sales indicator indicates whether an insurer will increase, decrease, or maintain an amount of business currently being solicited from potential insureds for the corresponding risk category.

41. A computer program in accordance with claim 40 further comprising at least one code segment that:
prompts the user to submit the recommended sales indicator for each risk category to an approval process of the insurer;
stores the approved sales indicators in the database; and
displays the approved sales indicators for each risk category on a computer system to enable a user to solicit business for the insurer based on the portfolio analysis and the market trends analysis.

42. A computer program in accordance with claim 41 further comprising a code segment that:
creates a data file representing an approved sales indicator including data relating to the risk category corresponding to the approved sales indicator; and
transmits the data file to an underwriting computer system for assigning the approved sales indicator for the risk category to at least one insurance contract included within the underwriting computer system.

43. A computer program in accordance with claim 41 further comprising a code segment that:
automatically creates data files representing each approved sales indicator for uploading to an underwriting computer system;
automatically creates an internal web showcase for an intranet for each approved sales indicator in an appropriate format and template;
automatically creates an external web showcase for the Internet for each approved sales indicator in an appropriate format and template; and
automatically creates a downloaded file showing each approved sales indicator and corresponding risk category for printing purposes.

44. A computer program in accordance with claim 41 further comprising a code segment that:
prompts a product leader for the insurer to propose updating a sales indicator for a selected risk category, the proposed updated sales indicator includes a proposal to at least one of change and maintain the selected sales indicator, and a reason for updating the sales indicator; and
communicates the proposed updated sales indicator from the product leader to a portfolio manager for the insurer.

45. A computer program in accordance with claim 44 further comprising a code segment that:
prompts the portfolio manager to accept or decline the updated sales indictor proposed by the product leader; and
communicates, if declined by the portfolio manager, the updated sales indicator proposed by the product leader to the product leader for further review until the product leader and the portfolio manager agree on the proposed updated sales indicator for the selected risk category.

46. A computer program in accordance with claim 45 further comprising a code segment that:
communicates the proposed updated sales indicator approved by the product leader and the portfolio manager to a risk manager for further review;
prompts the risk manager to confirm or question the proposed updated sales indicator; and
communicates, if questioned by the risk manager, the proposed updated sales indicator including at least one question submitted by the risk manager to the product leader such that the product leader can respond to the at least one submitted question.

47. A computer program in accordance with claim 46 further comprising a code segment that:
communicates the proposed updated sales indicator approved by the product leader, the portfolio manager, and the risk manager to a customer leader for further review;
prompts the customer leader to confirm or provide a market update to the product leader for the proposed updated sales indicator; and
communicates a market update from the customer leader to the product leader such that the product leader can respond to the market update.

48. A computer program in accordance with claim 47 further comprising a code segment that records the approved sales indicator for the selected risk category in the database after the proposed updated sales indicator for the selected risk category has been approved by the product leader, the portfolio manager, the risk manager, and the customer leader.

49. A computer program in accordance with claim 41 further comprising a code segment that stores in the database a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

50. A computer program in accordance with claim 41 further comprising a code segment that enables a system manager to monitor the approval process of each recommended sales indicator including an amount of time elapsed at each stage of the approval process.

51. A computer program in accordance with claim 41 further comprising a code segment that displays on the computer system a history for each risk category including at least one of proposed updates to the sales indicator, reasons for updating the sales indicator, whether the proposed update was accepted or declined, whether the proposed update was confirmed or questioned, questions relating to the proposed update, and market update requests for the proposed update.

52. A computer program in accordance with claim 41 further comprising a code segment that displays on the computer system a capacity limit for each risk category.

53. A computer program in accordance with claim 41 further comprising a code segment that segments the insurance products included within the portfolio into customer segments including at least one of global, national (U.S.), national (Rest of World), none, regional, and specialty.

54. A computer program in accordance with claim 41 further comprising a code segment that segments the insurance products included within the portfolio by agreement types including at least one of none, excess of loss (XOL), pro-rata, surplus, working, excess, catastrophic (Cat), per risk/per event, treaty excess liability, and facultative excess liability.

55. A computer program in accordance with claim 41 further comprising a code segment that segments the insurance products included within the portfolio into major lines of business.

56. A computer program in accordance with claim 41 further comprising a code segment that enables a user to generate a plurality of reports showing the approved risk-level indicators for each risk category including at least one of customizable reports, workflow events reports, strikezones overview reports, published strikezones reports, and system reports.

57. A method for targeting sales of insurance products using a computer system coupled to a database, the database storing data relating to insurance products previously sold by an insurer, the data relating to at least one of premiums, commissions, insurance policies, reinsurance policies, contracts, policy limits, claims, and losses, said method comprising:
determining a profitability for an insurance product sold by the insurer using the computer system to analyze data stored within the database;
analyzing market trends for at least a segment of an insurance industry; and
recommending a sales indicator for the insurance product for targeting future sales of the insurance product, the sales indicator is based on the profitability of the insurance product and the market trends analysis, the sales indicator indicates whether the insurer will increase, decrease, or maintain an amount of business currently being solicited from potential insureds for the insurance product.

58. A method in accordance with claim 57 wherein determining a profitability for an insurance product further comprises determining a profitability for each insurance product sold by the insurer using the computer system to analyze data stored within the database.

59. A method in accordance with claim 58 wherein recommending a sales indicator for the insurance product further comprises recommending a sales indicator for each insurance product offered for sale by the insurer for targeting future sales of the insurance products, the sales indicator is based on the profitability of each insurance product and the market trends analysis, the sales indicator indicates whether the insurer will increase, decrease, or maintain an amount of business currently being solicited from potential insureds for the corresponding insurance product.

60. A method in accordance with claim 57 further comprising:
approving by the insurer the recommended sales indicator for the insurance product;
storing the approved sales indicator in the database; and
displaying the approved sales indicator for the insurance product on the computer system.

61. A method in accordance with claim 60 wherein approving by the insurer the recommended sales indicator for the insurance product further comprises:
prompting a product leader to propose updating the sales indicator for the insurance product, the proposed updated sales indicator includes a proposal to at least one of change and maintain the sales indicator for the insurance product, and a reason for updating the sales indicator; and
communicating the proposed updated sales indicator from the product leader to a portfolio manager for the insurer.

62. A method in accordance with claim 61 wherein approving by the insurer the recommended sales indicator for the insurance product further comprises:
accessing by the portfolio manager the updated sales indicator proposed by the product leader;
prompting the portfolio manager to accept or decline the updated sales indictor proposed by the product leader; and
communicating, if declined by the portfolio manager, the updated sales indicator proposed by the product leader to the product leader for further review until the product leader and the portfolio manager agree on the proposed updated sales indicator for the insurance product.

63. A method in accordance with claim 62 wherein approving by the insurer the recommended sales indicator for the insurance product further comprises:
communicating the proposed updated sales indicator approved by the product leader and the portfolio manager to a risk manager for further review;
prompting the risk manager to confirm or question the proposed updated sales indicator; and
communicating, if questioned by the risk manager, the proposed updated sales indicator including at least one question submitted by the risk manager to the product leader such that the product leader can respond to the at least one submitted question.

64. A method in accordance with claim 63 wherein approving by the insurer the recommended sales indicator for the insurance product further comprises:
communicating the proposed updated sales indicator approved by the product leader, the portfolio manager, and the risk manager to a customer leader for further review;
prompting the customer leader to confirm or provide a market update to the product leader for the proposed updated sales indicator; and
communicating a market update from the customer leader to the product leader such that the product leader can respond to the market update.

65. A method in accordance with claim 64 wherein approving by the insurer the recommended sales indicator for the insurance product further comprises recording the approved sales indicator for the insurance product in the database after the proposed updated sales indicator for the insurance product has been approved by the product leader, the portfolio manager, the risk manager, and the customer leader.

66. A method in accordance with claim 60 wherein displaying the approved sales indicator for the insurance product further comprises displaying on the computer system a history for the insurance product including at least one of proposed updates to the sales indicator, reasons for updating the sales indicator, whether the proposed update was accepted or declined, whether the proposed update was confirmed or questioned, questions relating to the proposed update, and market update requests for the proposed update.

67. A method in accordance with claim 60 wherein displaying the approved sales indicator for the insurance product further comprises displaying on the computer system a capacity limit for the insurance product.

68. A network-based system for targeting sales of insurance products, said system comprising:
a database for storing data relating to insurance products previously sold by an insurer, the data relating to at least one of premiums, commissions, insurance policies, reinsurance policies, contracts, policy limits, claims, and losses; and
a computer system configured to be coupled to said database, said first computer system further configured to:
store data in said database;
determine a profitability for an insurance product sold by the insurer using the computer system to analyze data stored within the database;
analyze market trends for at least a segment of an insurance industry; and
prompt a user to recommend a sales indicator for the insurance product for targeting future sales of the insurance product, the sales indicator is based on the profitability of the insurance product and the market trends analysis, the sales indicator indicates whether the insurer will increase, decrease, or maintain an amount of business currently being solicited from potential insureds for the insurance product.

69. A system in accordance with claim 68 wherein said computer system is further configured to determine a profitability for each insurance product sold by the insurer using the computer system to analyze data stored within the database.

70. A system in accordance with claim 69 wherein said computer system is further configured to prompt a user to recommend a sales indicator for each insurance product offered for sale by the insurer for targeting future sales of the insurance products, the sales indicator is based on the profitability of each insurance product and the market trends analysis, the sales indicator indicates whether the insurer will increase, decrease, or maintain an amount of business currently being solicited from potential insureds for the corresponding insurance product.

71. A system in accordance with claim 68 wherein said computer system is further configured to:
transmit the recommended sales indicator for the insurance product to an approval process;
store the approved sales indicator in the database; and
display the approved sales indicator for the insurance product.

72. A system in accordance with claim 68 wherein said computer system is further configured to:
prompt a product leader to propose updating the sales indicator for the insurance product, the proposed updated sales indicator includes a proposal to at least one of change and maintain the sales indicator for the insurance product, and a reason for updating the sales indicator; and
communicate the proposed updated sales indicator from the product:
leader to a portfolio manager for the insurer.

73. A system in accordance with claim 72 wherein said computer system is further configured to:
enable a portfolio manager for the insurer to access the updated sales indicator proposed by the product leader;
prompt the portfolio manager to accept or decline the updated sales indictor proposed by the product leader; and
communicate, if declined by the portfolio manager, the updated sales indicator proposed by the product leader to the product leader for further review until the product leader and the portfolio manager agree on the proposed updated sales indicator for the insurance product.

74. A system in accordance with claim 73 wherein said computer system is further configured to:
communicate the proposed updated sales indicator approved by the product leader and the portfolio manager to a risk manager for further review;
prompt the risk manager to confirm or question the proposed updated sales indicator; and
communicate, if questioned by the risk manager, the proposed updated sales indicator including at least one question submitted by the risk manager to the product leader such that the product leader can respond to the at least one submitted question.

75. A system in accordance with claim 74 wherein said computer system is further configured to:
communicate the proposed updated sales indicator approved by the product leader, the portfolio manager, and the risk manager to a customer leader for further review;
prompt the customer leader to confirm or provide a market update to the product leader for the proposed updated sales indicator; and
communicate a market update from the customer leader to the product leader such that the product leader can respond to the market update.

76. A system in accordance with claim 71 wherein said computer system is further configured to display a history for the insurance product including at least one of proposed updates to the sales indicator, reasons for updating the sales indicator, whether the proposed update was accepted or declined, whether the proposed update was confirmed or questioned, questions relating to the proposed update, and market update requests for the proposed update.

77. A system in accordance with claim 71 wherein said computer system is further configured to display a capacity limit for the insurance product.

78. A system in accordance with claim 71 further comprising an underwriting computer system in communication with said computer system, said computer system is further configured to:
create a data file representing an approved sales indicator including data relating to the insurance product corresponding to the approved sales indicator; and
export the data file to the underwriting computer system for assigning the approved sales indicator for the insurance product to at least one insurance contract included within the underwriting computer system.

79. A system in accordance with claim 71 wherein said computer system is further configured to:
automatically create a data file representing the approved sales indicator for uploading to an underwriting computer system;
automatically create an internal web showcase for an intranet for the approved sales indicator in an appropriate format and template;
automatically create an external web showcase for the Internet for the approved sales indicator in an appropriate format and template; and
automatically create a downloaded file showing the approved sales indicator and the corresponding insurance product for printing purposes.
